(19) United States
(12) Patent Application Publication
(10) Pub. No.: US 2025/0089595 A1
(43) Pub. Date: Mar. 20, 2025

(54) AGRICULTURAL TOOLBAR

(71) Applicant: Harvest International, Inc., Storm Lake, IA (US)

(72) Inventors: Jeffrey Alan Sivinski, Cherokee, IA (US); Byron James Friesen, Storm Lake, IA (US)

(21) Appl. No.: 18/467,537

(22) Filed: Sep. 14, 2023

(51) Int. Cl. A01B 73/04

(52) U.S. Cl. CPC A01B 73/044

(57) ABSTRACT

A dual frame agricultural toolbar includes a lower front primary frame tube and an upper, rear truss frame tube. The front lower frame tube is adapted to support row units and other ground working tools, without interference from the upper rear frame tube. With the primary frame tube in front of the secondary frame tube, the row units and tools are located closer to the tractor, thereby minimizing power requirements for lifting the toolbar.

### TECHNICAL FIELD

The invention is directed toward an improved toolbar having a main transverse first bar and a staggered or offset secondary bar which functions as a structural truss for the first bar, and provides improved access to row units and other tools mounted to the first bar.

### BACKGROUND

Agricultural toolbars are typically mounted to the three-point hitch of a tractor, and support various tools for working the soil and planting seeds. The tools, such as row units, are mounted to the toolbar with U-bolts so as to extend rearwardly from the toolbar. The toolbar and mounted tools can be raised and lowered, and folded vertically or horizontally, between a field use position and a transport position. The farther the toolbar and tools are from the tractor, the more lifting power is required. Therefore, mounting the tools as close as possible to the three-point hitch connection with the toolbar minimizes lifting power required for the tractor.

Some toolbars are constructed as a single, transverse tube. Longer toolbars, which support more tools, require additional structural support as compared to shorter toolbars. These longer and stronger toolbars are often constructed with a primary transverse tube for supporting the tools and the secondary transverse tube connected by brackets to the primary tube so as to function as a truss. The secondary tube in some prior art toolbars is located in front of the primary tube, either at the same elevation or a raised elevation. This configuration of the dual-tube toolbar inherently spaces the tools further from the tractor, thus requiring additional lifting power to raise and lower the toolbar. Additional power means additional costs.

Some other dual tube or frame toolbars position the secondary truss tube behind the primary tube at the same elevation, which makes access to the row units and other tools more difficult, since the row units or tools are mounted between the primary and secondary tubes. This configuration makes maintenance and other work on the tools difficult and inconvenient. Also, these toolbars have rigid, structural tubes extending between the front and rear tubes or frame members, which further complicates work on the intermediate tools.

Therefore, a primary objective of the present invention is the provision of a dual frame toolbar having a primary frame member and a secondary frame member behind the primary frame member, so as to minimize the distance between tools and the tractor, and thereby minimize power requirements for the tractor.

Another objective of the present invention is the provision of a dual frame toolbar wherein a secondary frame member is behind and above the primary frame member, so as to provide better access to the tools on the primary frame member.

A further objective of the present invention is the provision of a dual frame toolbar which is free from connecting tubes extending between the lower front frame member and the upper rear frame member, thereby providing easier access to row units and other tools mounted on the primary frame member.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### SUMMARY

The dual frame toolbar of the invention has a primary frame tube connected to the three-point hitch of a tractor, and to which row units and other tools are mounted. Behind and above the primary frame tube is a secondary, structural support tube which functions as a truss to increase the strength and durability of the toolbar. The secondary trust tube is spaced above the row units or other tools, thereby providing easier access to the row units and tools for maintenance, repairs, replacement, or interchanging the tools with other tools. The rearward position of the secondary tube behind the primary tube allows the row units and tools to be positioned closer to the tractor, thereby minimizing the tractor lifting power.

### BRIEF DESCRIPTION OF THE DRAWINGS

FIG. 1 is a front, upper perspective view of the toolbar according to the present invention.

FIG. 2 is a front elevation view of the toolbar as shown in FIG. 1.

FIG. 3 is a rear elevation of the toolbar as shown in FIG. 1.

FIG. 4 is a top plan view of the toolbar shown in FIG. 1.

FIG. 5 is a partial sectional view of the toolbar showing the front, lower primary frame tube and the upper, rear secondary frame tube.

FIG. 6 is an elevation sectional view showing the lower front tube and upper rear tube, similar to FIG. 5.

FIG. 7 is another front perspective view of the toolbar as shown in FIG. 1 in the field position, without the wheels, seed assembly, and opposite end winglets.

FIG. 8 is another perspective view of the toolbar as shown in FIG. 7, folded to a transport position.

### DETAILED DESCRIPTION

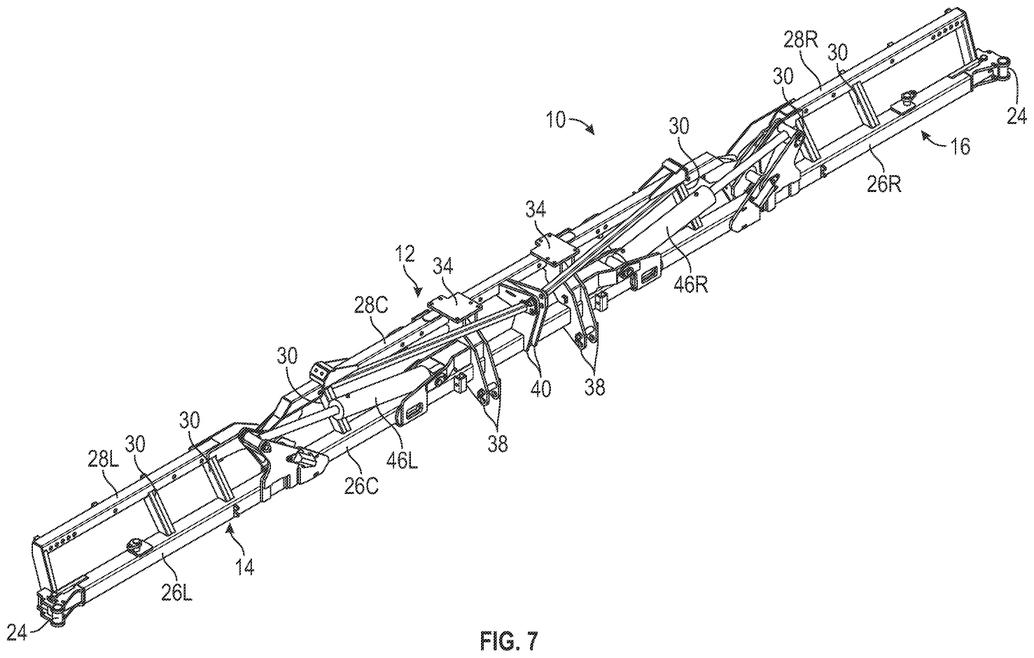

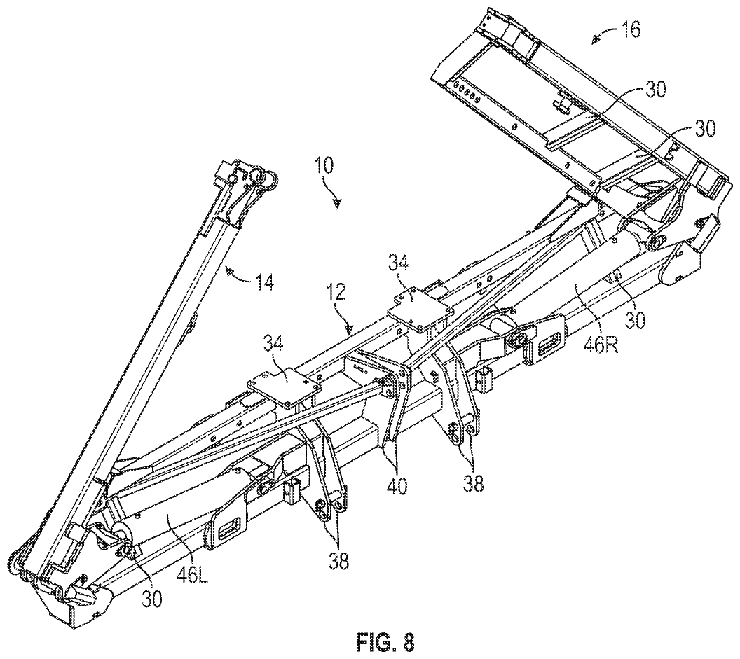

The toolbar of the present invention is generally designated in the drawings by the reference 10. The toolbar 10 includes a center section 12, a left wing section 14, and a right wing section 16. The left and right wing sections 14, 16 each have inner ends which are pivotally mounted to the opposite outer ends of the center section 12 for vertical folding movement about horizontal pivot axes 18. Thus, the left and right wing sections 14, 16 can fold between an extended field position, as shown in FIG. 7, and a retracted transport position, as shown in FIG. 8.

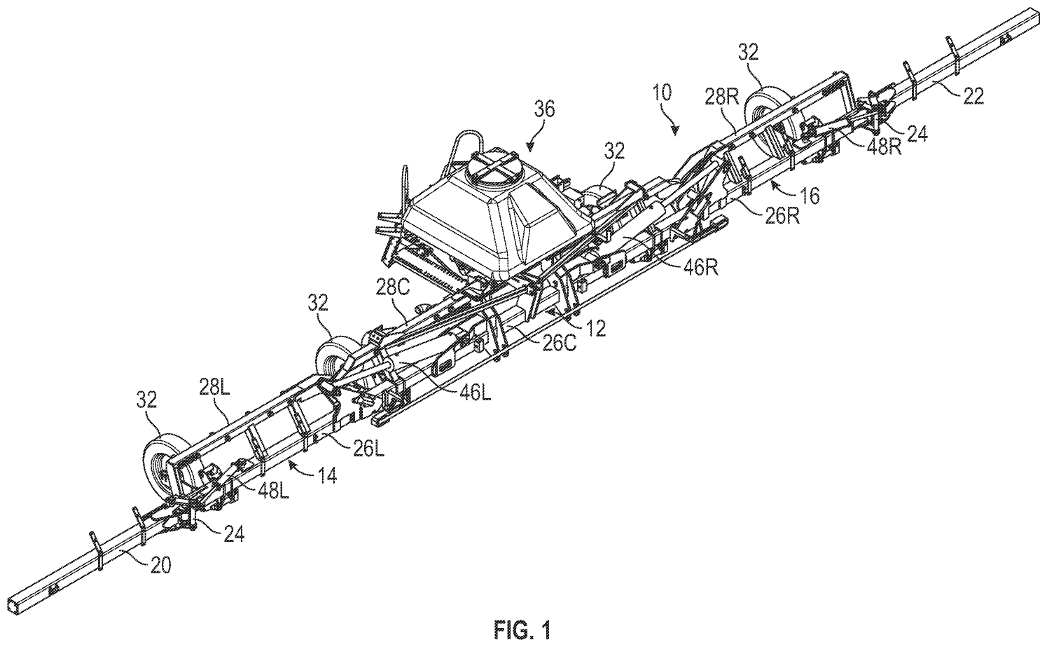

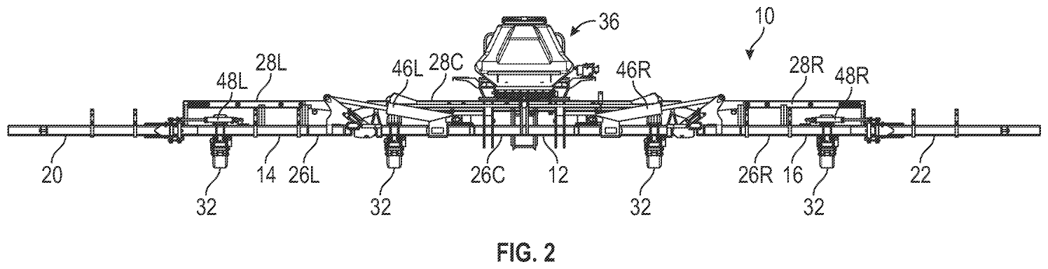

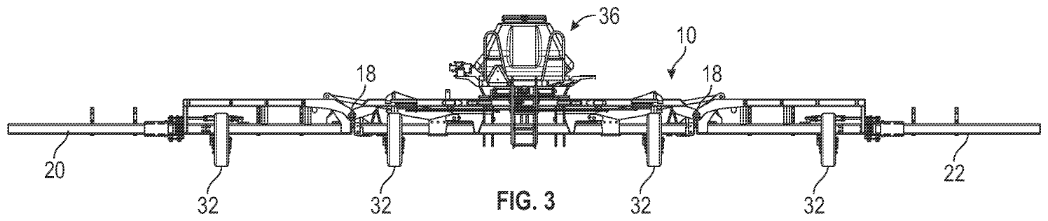

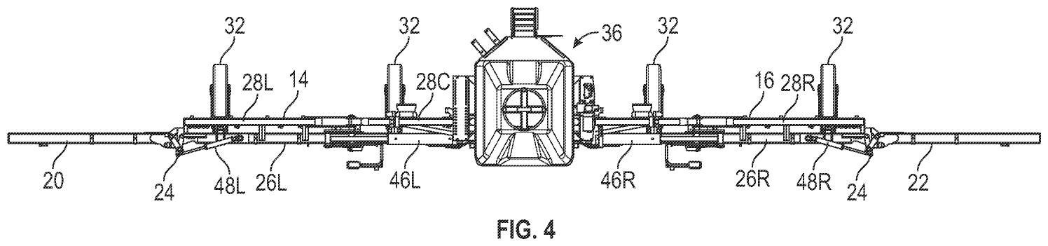

As shown in FIGS. 1-4, the toolbar 10 may also optionally include a left winglet 20 and a right winglet 22, which are pivotally mounted to the outer ends of the left and right wing sections 14, 16, respectively, for horizontal folding movement about vertical pivot axes 24. Thus, the winglets 20, 22 are foldable between an extended field position and a retracted transport position.

The toolbar 10 has a dual-frame construction, including a front, lower primary tube or frame member and an upper, rear secondary tube or frame member. The center section 12 includes a front, lower primary tube section 26C and an upper, rear secondary tube section 28C. Similarly, the left wing section 14 includes a lower front tube section 26L and an upper rear tube section 28L. The right wing section 16 includes a lower front tube section 26R and an upper rear tube section 28R. The lower tubes 26C, L and R are collectively referred to as the lower tube 26 (comprised of the three tube sections), and the upper tube sections 28C, L, R are collectively referred to as the upper tube 28 (comprised of the three tube sections). The tube sections 26C, L, R have co-linear axes, and the tube sections 28C, L, R have co-linear axes. The tubes 26, 28 are parallel to one another.

The lower tube 26 and the upper tube 28 are connected by rigid bars 30. Thus, the upper rear tube 28 functions as a structural truss for the lower front tube 26, thereby increasing the overall strength of the toolbar 10.

The lower front tube 26 is adapted to mount a plurality of wheels 32 using U-bolts or other connectors/fasteners. The lower front tube 26 and the winglets 20, 22 are also adapted to mount a plurality of row units or other tools (not shown) for use in planting seeds or working the soil. The row units and tools can be mounted using any known means, such as U-bolts. The row units and tools are conventional, and do not constitute part of the present invention.

The upper rear tube or frame member 28 includes horizontal plates 34 to which a tank assembly can be secured. The tank assembly 36 may be used for a variety of agricultural products to be used in a field, such as bulk seed, fertilizer, herbicides, or liquids. The tank assembly 36 is conventional, and does not constitute part of the present invention.

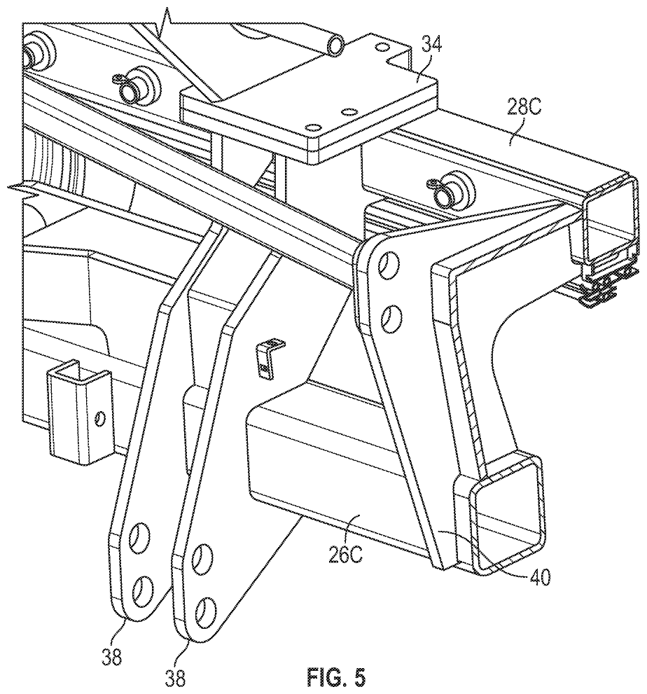

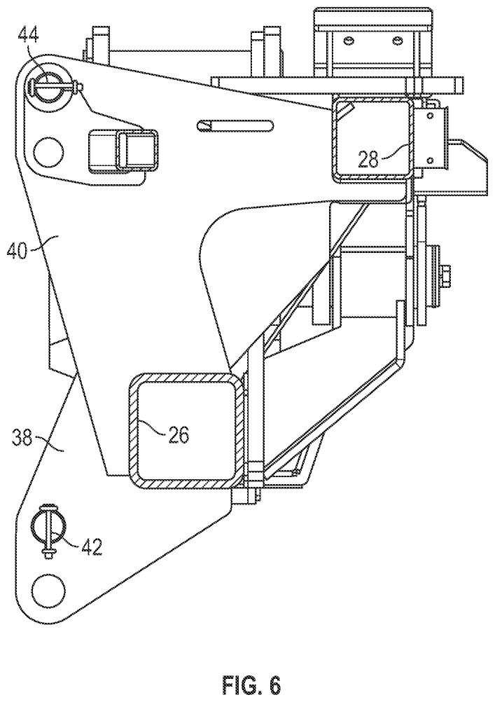

As best seen in FIGS. 5 and 6, the toolbar tubes or frame members 26, 28 are parallel to one another, but are offset or staggered relative to one another. The lower tube 26 resides in front of the upper tube 28, and is adapted to be attached to a three point hitch of a tractor. Thus, the front lower tube 26 is positioned as close as possible to the three point hitch and to the tractor, thereby decreasing the overhanging load lifting requirements of the tractor.

The upper rear tube 28 is positioned above the row units or tools, which are mounted on the lower tube 26, thereby providing easier access to the row units, for example to simplify changing of seed crop metering discs, and to otherwise service the toolbar and row units/tools. Also, since the upper tube 28 is behind the primary tube 26, rather than in front of the primary tube as in some prior art, the primary tube 26 can be positioned closer to the tractor to reduce the power requirements for lifting the overhanging load. The upper rear truss tube 28 also structurally strengthens the toolbar 10 to resist deflection in both the field position and the transport position.

The toolbar 10 is adapted to be connected to a three point hitch of a tractor via plates 38, 40 which are fixed to the tubes 26, 28. The lower arms of the three point hitch are attached to the plates 38 via a pin 42 or another fastener. The upper arm of the three point hitch is secured to the plate 40 with a pin 44, or another fastener.

Left and right hydraulic cylinders 46L and 46R, respectively, have opposite ends connected to the center section 12 and to the respective left and right wing sections 14, 16. The cylinders 46L, 46R can be extended and retracted to move the wing sections 14, 16 between the field and use positions. If the winglets 20, 22 are provided on the toolbar 10, hydraulic or pneumatic cylinders 48B and 48R have opposite ends connected to the wing sections 16, 18 and the winglets 20, 22, respectively to fold the winglets between the extended field position and a retracted transport station.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. An agricultural toolbar, comprising:
a center section and opposite wing sections; and
each center and wing section including upper and lower transverse bars spaced vertically and horizontally apart, with the upper transverse bar being behind the lower transverse bar.

2. The agricultural toolbar of claim 1 wherein the upper and lower bars of the respective center and wing sections are connected to one another.

3. The agricultural toolbar of claim 1 wherein the upper bar is parallel to the lower tool bar for each center and wing section.

4. The agricultural toolbar of claim 1 wherein the lower bar has a bigger cross section than the upper bar for each center and wing section.

5. The agricultural toolbar of claim 1 wherein the upper bar of each section function as a truss support for the lower bar of each respective section.

6. The agricultural toolbar of claim 1 wherein the upper bar of the center section is adapted to support a tank assembly.

7. The agricultural toolbar of claim 1 wherein the wing sections fold vertically relative to the center section.

8. The agricultural toolbar of claim 1 wherein the upper bars have coextensive axes and lower bars have coextensive axes.

9. The agricultural toolbar of claim 1 wherein the wing sections have inner ends pivotally connected to outer ends of the center section for vertical folding about a horizontal axis between field and transport positions.

10. The agricultural toolbar of claim 1 wherein the upper bars extend colinearly with one another and the lower bars extend colinearly with one another.

11. An agricultural toolbar having a center section and opposite left and right wing sections, and further comprising:
front and rear vertically staggered bars on the center section;
front and rear vertically staggered bars on each wing section;
the front bars being adapted to support a plurality of wheels and tools; and
the rear bars residing above the wheels and tools, and providing truss support for the front bars.

12. The agricultural toolbar of claim 11 wherein the front bar of the center section and the front bars of the wing sections each have a longitudinal axis which are coextensive with one another.

13. The agricultural toolbar of claim 12 wherein the rear bar of the center section and the rear bars of the wing sections each have a longitudinal axis which are coextensive with one another.

14. The agricultural toolbar of claim 13 wherein the longitudinal axes of the front and rear bars of the center and wing sections are parallel to one another.

15. The agricultural toolbar of claim 11 the rear bars are free from tools being mounted thereon.

16. The agricultural toolbar of claim 11 wherein the wing sections pivot vertically between a field position and a transport position.

17. The agricultural toolbar of claim 11 wherein the rear bars of the center and wing sections reside at a higher elevation than the front bars of the center and wing sections.

18. The agricultural toolbar of claim 11 wherein the front and rear bars on the center section are interconnected, the front and rear bars on the left wing section are interconnected, and the front and rear bars on the right wing sections are interconnected.

19. The agricultural toolbar of claim 11 wherein the rear bar of the center section has plates adapted to support a tank assembly.

20. The agricultural toolbar of claim 11 further comprising extensible and retractable cylinders connected to the center section and respective ones of the wing sections to fold the wing sections between field and transport positions relative to the center section.
